(19) United States
(12) Patent Application Publication
(10) Pub. No.: US 2026/0097743 A1
(43) Pub. Date: Apr. 9, 2026

(54) BATTERY SWAPPING SYSTEM, BATTERY SWAPPING METHOD AND BATTERY PACK FOR ELECTRIC VEHICLE

(71) Applicant: ZHONGYUAN UNIVERSITY OF TECHNOLOGY, Zhengzhou (CN)

(72) Inventors: Shaohua ZHOU, Zhengzhou (CN); Jianguo MA, Zhengzhou (CN)

(21) Appl. No.: 19/348,757

(22) Filed: Oct. 2, 2025

(30) Foreign Application Priority Data
Oct. 9, 2024 (CN) 202411407190.9

(51) Int. Cl. B60S 5/06; B60L 50/60; B60L 50/64; B60L 58/10

(52) U.S. Cl. CPC B60S 5/06; B60L 50/64; B60L 50/66; B60L 58/10

(57) ABSTRACT

A battery swapping system, a battery swapping method and a battery pack for an electric vehicle are used for providing electric energy to an electric vehicle by means of battery swapping, wherein the electric vehicle comprises a plurality of battery cells, and the battery swapping system comprises a system manager and a battery swapping station. The system manager formulates a battery swapping plan on the basis of a purchase instruction and the remaining power of the electric vehicle, wherein the system manager sends the battery swapping plan to the battery swapping station, and on the basis of the battery swapping plan, the battery swapping station removes depleted battery cells of the electric vehicle and installs a corresponding number of fully-charged battery cells instead.

### CROSS-REFERENCE TO RELATED APPLICATIONS

The present application claims the priority of Chinese patent application No. 202411407190.9, filed on Oct. 9, 2024, which is hereby incorporated by reference in its entirety.

### TECHNICAL FIELD

The present disclosure relates to the technical field of electric vehicles, and in particular to a battery swapping system, a battery swapping method and a battery pack for an electric vehicle.

### BACKGROUND

Energy resource and environmental pollution have become one of the most concerned issues in the world. Traditional fuel vehicles, as the main consumers of non-renewable oil resources and emitters of serious environmental pollution, are gradually being replaced by New Energy Electric Vehicles (NEEV). New Energy Electric Vehicles use “electricity” instead of “fuel oil”, which can achieve “zero pollution” and “green and environmentally friendly travel”. It is the most effective solution to the current energy resource and environmental pollution problems. The construction of battery swapping stations for New Energy Electric Vehicles can achieve rapid charging of New Energy Electric Vehicles and extend their driving range, which is the cornerstone for advancing the development of the industry chain of New Energy Electric Vehicles.

The battery swapping stations for New Energy Electric Vehicles are automatic battery swapping equipments that quickly replace batteries for electric vehicles to resolve the range issue thereof, so as to achieve the purpose of “powering up” electric vehicles. At present, China vigorously subsidizes New Energy Vehicle (NEV) companies to advance the development of electric vehicle technology, especially to provide policy and resource support for New Energy Vehicle companies that can swap batteries. The battery swapping technology for electric vehicles is the main development direction and trend of promoting electric vehicles in the future.

The existing electric vehicles and battery swapping station systems still have at least one of the following technical defects:
(1) Chassis differentiation of New Energy Electric Vehicles. Each automobile brand and model is produced independently, and there is no unified standard for the chassis of battery swapping vehicles. The development of New Energy Electric Vehicle technology in China is relatively early. At present, there are three main battery swapping methods: Z-direction vertical plug-in, side-pull plug-in, and parallel lateral plug-in. Small vehicles such as sedans and SUVs use the Z-direction vertical plug-in or parallel lateral plug-in. Due to the large size of the power battery, the power battery is placed on the chassis for most battery swapping vehicles. On the one hand, it can make full use of the limited space of the vehicle body; on the other hand, it concentrates the weight of the vehicle on the chassis, lowers the center of gravity, and increases the driving stability of the vehicle. The battery swapping technology requires that the vehicle's power battery must be replaced within 1-3 minutes, so the chassis of electric vehicles is open, and the chassis structure is comprehensively remodeled and enhanced to facilitate the removal and installation of the power battery. However, the chassis structure of each vehicle company is not unified, resulting in inconsistency in terms of battery swapping device.
(2) Battery differentiation. Electric vehicles have respective brands and models, and their own batteries are suitable for their models. Batteries cannot be shared by different brands and models. There are many different types of batteries on the market, and their energy storage is also different. According to the new policy of China, electric vehicles with a range of less than 300 km will be phased out. Various vehicle companies and battery manufacturers have increased their research and development efforts to increase battery energy storage and increase the driving range of electric vehicles. However, there are still many different batteries that cannot be unified.
(3) The technical threshold is high, and a large amount of funds is required to build and operate the stations. In recent years, battery swapping technology has developed rapidly, the sales of New Energy Vehicles have continued to increase, and the number of battery swapping stations being built has also increased. However, the separation between vehicles and batteries requires the OEM to redesign and verify the vehicle chassis, body structure, power battery, etc., and to change the production line, and the cost is high. Battery swapping technology is also a new technology that has neither technical knowledge reserves nor experience accumulation, and requires a large amount of R&D funds. At the same time, it requires a large amount of funds to build and operate the stations, and the profit period is long. In addition to the battery swapping business, a battery swapping station also needs to charge, test, and maintain the battery, which requires a professional operation team to carry out maintenance. Many companies cannot bear the financial pressure and continue to wait and see. Only a few companies have invested in trial operation in small batches.

Due to the differentiation of chassises and batteries in relation to the automobile models as mentioned above (power batteries produced by different manufacturers are different in terms of battery size, interface and layout), battery swapping stations can only replace batteries of their own brand models, which cannot be interchanged and shared. As a result, battery swapping stations cannot be connected to a network. Even if a model is deployed with multiple stations, it is impossible to share all vehicle series like gas stations. The description here only provides background information related to the present disclosure and does not necessarily form the prior art.

Therefore, how to deal with these issues becomes an urgent problem to be solved.

### SUMMARY

A major advantage of the present disclosure is to provide a battery swapping system, a battery swapping method and a battery pack for an electric vehicle, wherein the battery swapping system, the battery swapping method and the battery pack can solve the problems existing in the current battery swapping process of electric vehicles, such as chassis differentiation, battery differentiation and high technical threshold.

Another advantage of the present disclosure is to provide a battery swapping system, a battery swapping method and a battery pack for an electric vehicle, wherein, by centrally managing and using batteries, battery performance can be better maintained and battery life can be extended. Even after retirement, the batteries can be effectively recycled and reused, thereby maximizing resource utilization.

Another advantage of the present disclosure is to provide a battery swapping system, a battery swapping method and a battery pack for an electric vehicle, which can quickly replace batteries, save time, and greatly improve the use efficiency of New Energy Vehicles.

Another advantage of the present disclosure is to provide a battery swapping system, a battery swapping method and a battery pack for an electric vehicle, to solve the problem of driving range and make “range anxiety” no longer a problem.

Another advantage of the present disclosure is to provide a battery swapping system, a battery swapping method and a battery pack for an electric vehicle, wherein, through the vehicle-battery separation mode, the battery is owned and managed by an asset company and rented to consumers. A purchaser only needs to pay a vehicle purchase fee without the battery and a battery rental fee. This reduces the purchase threshold for consumers by tens of thousands of yuan at one time, and at the same time does not have to bear the loss of battery depreciation. Customers can choose to rent batteries of different specifications according to different travel needs each time.

Another advantage of the present disclosure is to provide a battery swapping system, a battery swapping method and a battery pack for an electric vehicle with considering that: Accidents caused by rapid charging of electric vehicles have been common in the past few years, and high-power rapid charging is the main cause of fires in electric vehicles. The point where the stability of the power battery decreases is after 300-500 fast charging cycles. The thermal runaway temperature of an ordinary new battery is about 215° C., and the critical point of thermal runaway of a battery that is fast charged too much will be greatly reduced to 107° C., which is more likely to trigger battery thermal runaway and cause a fire. The battery swapping mode can avoid rapid charging with high-intensity of the power battery and ensure safety.

Another advantage of the present disclosure is to provide a battery swapping system, a battery swapping method and a battery pack for an electric vehicle, wherein in the battery swapping system, the battery swapping method and the battery pack, the model, size, interface and installation method of a battery are described, and a vehicle-battery separation mode is adopted, so that battery swapping stations for New Energy Electric Vehicles can overcome existing difficulties and realize sharing of all vehicle series like gas stations.

Another advantage of the present disclosure is to provide a battery swapping system, a battery swapping method and a battery pack for an electric vehicle, wherein the battery swapping system adopts a “vehicle-battery separation” mode, and a special place is reserved on the electric vehicle to install a universal battery pack (UBP), which realizes the universalization, standardization and modularization of battery interfaces of different automobile manufacturers. The universal battery pack can provide a driving range of hundreds of kilometers or more, and the battery can be swapped in a battery swapping station. The universal battery pack (UBP) is composed of N identical batteries.

Another advantage of the present disclosure is to provide a battery swapping system, a battery swapping method and a battery pack for an electric vehicle, wherein the interface of the battery pack (UBP) of a battery pack assembly adopts a unified interface, which is suitable for different types of vehicle series.

Another advantage of the present disclosure is to provide a battery swapping system, a battery swapping method and a battery pack for an electric vehicle, wherein the battery pack (UBP) of a battery pack assembly is mounted in a unified manner, which is suitable for different types of vehicle series.

Another advantage of the present disclosure is to provide a battery swapping system, a battery swapping method and a battery pack for an electric vehicle, wherein the battery packs use the same model, and universal battery packs (UBPs) of different capacities achieve different driving ranges, which are suitable for all vehicle series, whereas the existing battery swapping mode is only applicable to models of the same brand and is not compatible with other brands.

Another advantage of the present disclosure is to provide a battery swapping system, a battery swapping method and a battery pack for an electric vehicle, wherein the battery swapping system adopts a “vehicle-battery separation” mode, which reduces the purchase threshold for consumers by tens of thousands of yuan at one time, while not having to bear the loss of battery depreciation. Customers can choose to rent batteries of different specifications according to their different travel needs each time, “so that it can be as convenient as refueling.”

Another advantage of the present disclosure is to provide a battery swapping system, a battery swapping method and a battery pack for an electric vehicle, wherein the battery swapping system simplifies the battery swapping method of electric vehicles, allowing users to swap batteries by themselves, remove depleted battery cells without disassembling the entire battery pack, and install fully-charged battery cells on the battery rack, thereby simplifying the battery swapping operation process.

Another advantage of the present disclosure is to provide a battery swapping system, a battery swapping method and a battery pack for an electric vehicle, wherein the battery pack allows a user to replace a single battery in the battery pack or replace all the battery cells in the battery pack, and the user can swap the battery on demand as needed.

Another advantage of the present disclosure is to provide a battery swapping system, a battery swapping method and a battery pack for an electric vehicle, wherein the battery pack can be mounted on the chassis of an electric vehicle, or mounted on the top of the vehicle or hung at other positions in the vehicle, or mounted in the vehicle's original battery tray, that is, the battery pack can be used as a backup battery or main battery of the vehicle, thereby improving the use scenarios of the battery pack.

Another advantage of the present disclosure is to provide a battery swapping system, a battery swapping method and a battery pack for an electric vehicle, wherein it is possible for the battery swapping system to swap a battery pack according to the user's usage requirements, thereby meeting the power needs and also avoiding increasing the weight of the vehicle body due to too many batteries.

Another advantage of the present disclosure is to provide a battery swapping system, a battery swapping method and a battery pack for an electric vehicle, wherein it is possible for the battery swapping system to distribute power to the battery pack according to the user's usage requirements, facilitating the increase in the service life of the battery and the vehicle.

Another advantage of the present disclosure is to provide a battery swapping system, a battery swapping method and a battery pack for an electric vehicle, wherein it is possible for the battery swapping system to configure power distribution to the battery cells in the battery pack, helping to avoid problems caused by uneven use of the battery pack, and facilitating the increase in the service life of the battery.

Another advantage of the present disclosure is to provide a battery swapping system, a battery swapping method and a battery pack for an electric vehicle, wherein the battery swapping system enables the cascade utilization of battery pack(s) for battery energy storage, thereby extending the battery life.

According to one aspect of the present disclosure, a battery swapping system of the present disclosure that can achieve the aforementioned objectives and other objectives and advantages is used to provide electric energy to an electric vehicle by means of battery swapping, wherein the electric vehicle comprises a plurality of battery cells, the battery swapping system comprising:

a system manager formulating a battery swapping plan on the basis of a purchase instruction and the remaining power of the electric vehicle; and

a battery swapping station, wherein the system manager sends the battery swapping plan to the battery swapping station, and on the basis of the battery swapping plan, the battery swapping station removes depleted battery cells of the electric vehicle and installs a corresponding number of fully-charged battery cells instead.

According to an embodiment of the present disclosure, the battery swapping station comprises a battery swapping device, a charging device and a power distribution device, wherein the battery swapping device is configured to disassemble the depleted battery cells of the electric vehicle and install the configured and ready fully-charged battery cells into a battery pack of the electric vehicle, and the charging device is configured to charge the depleted battery cells and store the battery cells; and instructions of the power distribution device and the system manager are issued for configuring the battery cells for the electric vehicle to meet a power consumption demand of the electric vehicle.

According to an embodiment of the present disclosure, the battery swapping system further comprises an information acquisition module, wherein the information acquisition module acquires data of the electric vehicle being swapped and information about charging and discharging of each battery cell, wherein the information acquisition module transmits the acquired data and information to the system manager.

According to an embodiment of the present disclosure, the battery swapping system further comprises a detection module for detecting the battery cells and transmitting detection results to the system manager.

According to an embodiment of the present disclosure, the detection module comprises a fault detection module and a battery monitoring module, wherein the fault detection module is configured to perform fault detection on the battery cells, and the battery monitoring module is configured to monitor a usage state of a battery during use.

According to another aspect of the present disclosure, the present application further provides a battery swapping method for an electric vehicle, wherein the battery swapping method comprises the following steps:
(a) obtaining a purchase instruction for swapping a battery for the electric vehicle, and formulating a battery swapping plan on the basis of the purchase instruction and the remaining power of the electric vehicle; and
(b) on the basis of the battery swapping plan, removing depleted battery cells from the electric vehicle and installing fully-charged battery cells.

According to an embodiment of the present disclosure, in step (a) of the battery swapping method, the electric vehicle sends the purchase instruction and the remaining power information of the electric vehicle to the system manager, or an information acquisition module obtains the purchase instruction of the electric vehicle, and transmits the purchase instruction to the system manager.

According to an embodiment of the present disclosure, in step (a) of the battery swapping method, the purchase instruction is formulated on the basis of a power purchase demand, and the purchase instruction is sent to the system manager.

According to an embodiment of the present disclosure, the battery swapping method further comprises the following step: (c) acquiring battery information of the depleted battery cells and the fully-charged battery cells, and uploading the battery information to the system manager, and the system manager records the number of charging and discharging cycles and usage records of the battery cells.

According to an embodiment of the present disclosure, the battery swapping method further comprises the following step: (d) configuring a discharge sequence of the respective battery cells in the electric vehicle on the basis of the battery swapping plan of the electric vehicle.

According to a further aspect of the present disclosure, the present application provides a battery pack for an electric vehicle suitable for use in the battery swapping system as described above, comprising:

a battery mounting frame;

a plurality of battery cells, wherein the plurality of battery cells are detachably mounted on the battery mounting frame; and

an adapter assembly, wherein the adapter assembly comprises an input interface, an output interface and a power management unit connecting the input interface and the output interface, the respective battery cells are connected to the input interface of the adapter assembly, and the output interface is adapted to connect to a power input terminal of the electric vehicle, and wherein the power management unit converts electric energy output by the battery cells into electric energy adapted to input to the electric vehicle;

wherein the respective battery cells are independent of each other, and each can be removed from and mounted to the battery mounting frame separately.

Further objectives and advantages of the present disclosure will be fully embodied through the understanding of the following description and the drawings.

These and other objectives, features and advantages of the present disclosure are fully embodied by the following detailed description and accompanying drawings.

### BRIEF DESCRIPTION OF THE DRAWINGS

The technical solution of the present disclosure will be further described in detail below with reference to the accompanying drawings and embodiments. In the accompanying drawings, unless otherwise specified, the same reference signs are used to represent the same components. In the accompanying drawings:

FIG. 1 is a schematic diagram of an installation position of a vehicle battery pack according to a first preferred embodiment of the present disclosure.

FIG. 2 is a schematic block diagram of the battery structure of the vehicle battery pack according to the above preferred embodiment of the present disclosure.

FIG. 3 is a schematic structural diagram of the vehicle battery pack according to the above preferred embodiment of the present disclosure.

FIG. 4 is a schematic diagram of the configuration structure of the vehicle battery pack according to the above preferred embodiment of the present disclosure.

FIG. 5 is a schematic diagram of a system framework of a battery swapping system according to another preferred embodiment of the present disclosure.

FIG. 6 is a schematic diagram of a battery swapping process of the battery swapping system according to the above preferred embodiment of the present disclosure.

FIG. 7 is a schematic diagram of method steps of a battery swapping method for the battery swapping system according to the above preferred embodiment of the present disclosure.

### DETAILED DESCRIPTION

It should be pointed out that the embodiments shown in the accompanying drawings are only used as examples to specifically and vividly explain and illustrate the concept of the present disclosure. The size and structure thereof are not necessarily drawn to scale, nor do they constitute a limitation to the concept of the present disclosure.

The directional or positional terms such as up, down, left, right, front, rear, front side, back side, top, bottom, etc. which are mentioned or may be mentioned in this specification are defined relative to the structures/arrangements shown in the respective figures. They are relative concepts and may change accordingly in terms of different positions and different usage conditions thereof. Therefore, these or other directional or positional terms should not be interpreted as restrictive terms.

It may be understood that the term “a” or “an” should be interpreted as “at least one” or “one or more”, that is, in one embodiment, the number of an element may be one, and in other embodiments, the number of the element may be multiple. The term “a” or “an” cannot be understood as a limitation on the number. Additionally, in the present application, given the conventional descriptive practices in the art, the terms “battery” and “battery cell” are not strictly distinguished and may generally convey the same meaning. In contexts where they refer to different specific entities, those skilled in the art will correctly understand their respective technical implications.

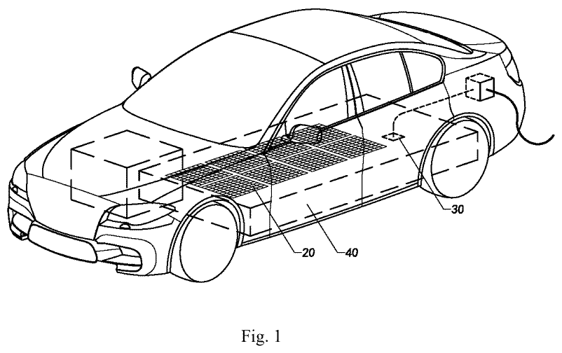

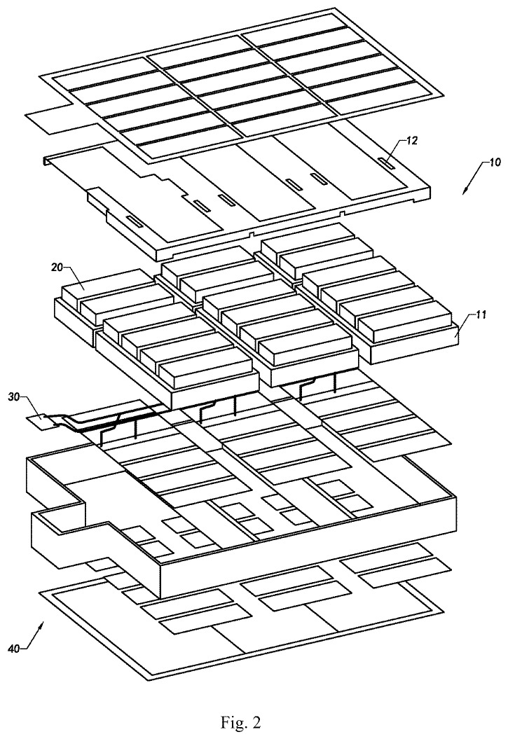

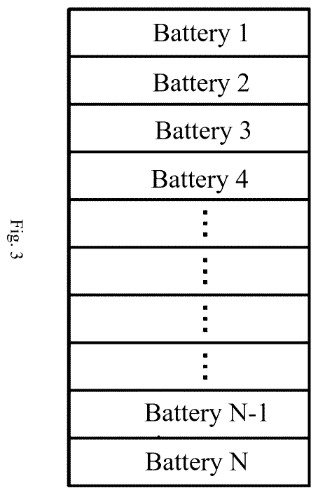

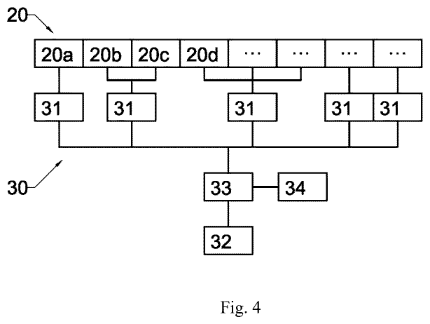

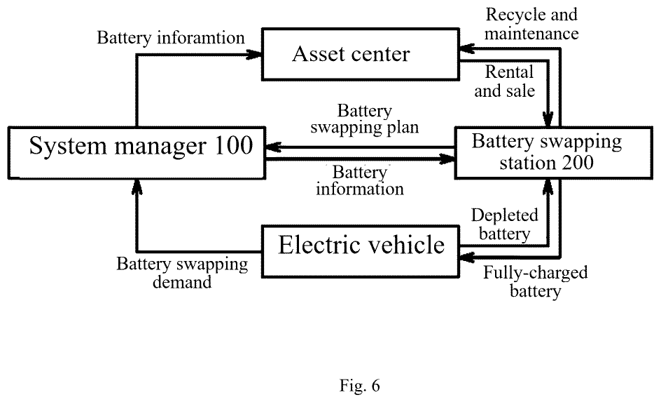

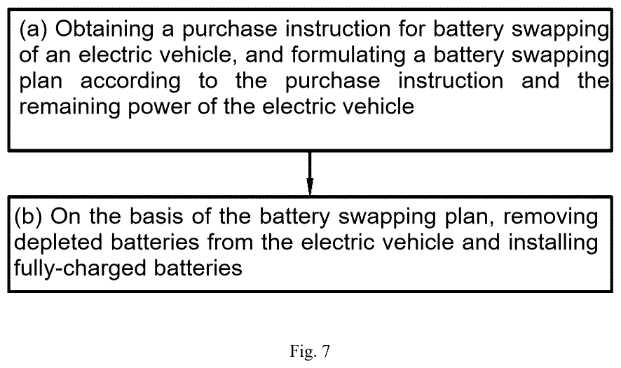

Referring to FIGS. 1 to 7 of the accompanying drawings of the present disclosure, a battery swapping system, a battery swapping method and a battery pack for an electric vehicle according to a first preferred embodiment of the present application are shown. Since the power batteries of most New Energy Vehicles are currently fixed on the chassis of the vehicles, the battery swapping technology is not applicable, and the vehicles can only be charged with charging piles. Even if the so-called “super charging” can shorten the charging time, the current and voltage passing through the respective battery are too large in a short time, which results in a reduction in the recovery/regeneration ability of the power battery, a reduction in the number of charging and discharging cycles of the battery, and an acceleration of the attenuation of the battery capacity, thereby shortening the service life of the power battery. Moreover, short-term high-power charging causes high infrastructure requirements. The battery swapping station may reserve multiple batteries according to the number of vehicles at an actual location, charge each battery using slow charging, and balance the battery voltage, thereby extending the battery life. The vehicles can quickly swap the batteries at the battery swapping station. In addition, after each battery swapping, the battery swapping station system will detect the relevant battery. If maintenance is required, the system will automatically upload to a terminal and notify the personnel to maintain the battery to ensure the normal use of the battery, objectively reducing the damage to the power battery and the attenuation of the capacity, and extending the battery life. When a battery decays to the point where it cannot be used at the vehicle end, it will be used in a cascade (“cascade utilization”) and applied to the energy storage end, so that the battery can be reused to create value.

At present, the batteries of New Energy Vehicles are mainly charged through charging piles. Even with high-power DC fast charging, the full charging time is generally 0.5 to 2 hours, whereas the battery swapping time is generally 1 to 3 minutes. The slowest battery swapping is about 1/10 of the time required for fast charging, which is almost the same as or faster than the time it takes to refuel a vehicle. This greatly shortens the charging time of pure electric vehicles and greatly improves the utilization efficiency of New Energy Vehicles.

At the current stage, the vehicle-to-charging pile ratio for electric vehicles is 3.4:1, and there is still a significant shortage of charging piles, especially in highway service areas, where the number of charging piles is small, the charging speed is slow, and the device fault rate is high, so that the needs of New Energy Vehicles for long-distance driving cannot be met. The rapid construction of battery swapping stations can make up for the shortage of charging piles. The battery swapping time is short, which is equivalent to or shorter than the refueling time. In addition, the battery swapping stations are independently built by dedicated operating companies, and there are professional teams responsible for operation and subsequent maintenance, which can ensure the long-term and stable use of the battery swapping stations. At present, battery swapping technology is the most ideal solution to the problem of driving range.

In the preferred embodiment of the present application, the battery swapping system operates in a vehicle-battery separation mode, where the battery is owned and managed by an asset company and rented to consumers. An purchaser only needs to pay a vehicle purchase fee without the battery and a battery rental fee. This reduces the purchase threshold for consumers by tens of thousands of yuan RMB at one time, while not having to bear the loss of battery depreciation. Customers can choose to rent batteries of different specifications according to their different travel needs each time, “so that it can be as convenient as refueling.”

Accidents caused by rapid charging of electric vehicles have been common in the past few years, and high-power rapid charging is the main cause of fires in electric vehicles. Among New Energy Vehicle accidents, fast charging caused 29% of them. The point where the stability of the power battery decreases is after 300-500 fast charging cycles. The thermal runaway temperature of an ordinary new battery is about 215° C., and the critical point of thermal runaway of a battery that is fast charged too much will be greatly reduced to 107° C., which is more likely to trigger battery thermal runaway and cause a fire. The battery swapping mode can avoid high-intensity rapid charging of the power battery and ensure safety.

It is worth mentioning that in the preferred embodiment of the present application, battery packs for electric vehicles adopt unified standards for battery models, interfaces and installation methods, which can share various vehicle series like gas stations.

As shown in FIGS. 1 to 4, in the preferred embodiment of the present application, the battery pack is a charging and discharging device suitable for an electric vehicle, wherein the battery pack may be mounted in at least one or more positions of the chassis, rear, interior space of the vehicle body, roof or trunk of the electric vehicle. It can be understood that the electric vehicle is provided with one or more battery trays for installing batteries, wherein the battery pack may be mounted in the battery tray of the electric vehicle, that is, the battery pack may be used as the main battery of the electric vehicle; or the battery pack may be mounted in other position(s) of the vehicle in a fixed or non-fixed manner, that is, the battery pack may be used as a secondary battery of the electric vehicle to provide the electric vehicle with electrical energy required for operation.

The battery pack is suitable for different types of vehicles, and may provide corresponding power supply plans or driving ranges according to actual usage needs of users. It is worth mentioning that in the preferred embodiment of the present application, the battery pack is mounted on the chassis of the vehicle, wherein a specific implementation of the battery pack may be, but is not limited to, Z-direction vertical plug-in, side-pull plug-in, and parallel lateral plug-in battery assemblies. As an example, in the preferred embodiment of the present application, the battery pack is mounted below the chassis of the electric vehicle.

In detail, the battery pack includes a battery mounting frame 10, and a plurality of battery cells 20 and an adapter assembly 30 that may be fixed on the battery mounting frame 10, wherein the adapter assembly 30 is electrically connected to the battery cells 20, the adapter assembly 30 may be conductively connected to the electric vehicle, and power is supplied to the electric vehicle through the adapter assembly 30. The battery mounting frame 10 may be fixedly mounted on the chassis of the electric vehicle or other positions of the vehicle, such as the top or trunk of the vehicle.

In the preferred embodiment of the present application, the battery mounting frame 10 is mounted in the battery tray of the electric vehicle, wherein the adapter assembly 30 electrically connects the respective battery cell 20 to the power input interface of the electric vehicle. The battery mounting frame 10 includes a plurality of mounting receptacles 11 and a fixing mechanism 12 for fixing the battery cells 20, wherein the battery cells 20 may be mounted in the mounting receptacles 11 of the battery mounting frame 10, and the respective battery cells 20 are fixed to the respective mounting receptacles 11 by the fixing mechanism 12 to prevent the battery cells 20 from moving. The fixing mechanism 12 may fix the battery cells 20 to the mounting receptacles 11. As an example, in the preferred embodiment of the present application, the fixing mechanism 12 may be, but is not limited to, a mounting mechanism such as a bolt or a buckle or snap fastener.

It should be noted that, in the preferred embodiment of the present application, the respective battery cells 20 are independent of each other, and each can be removed from and mounted to the battery mounting frame 10 separately. Therefore, in the preferred embodiment of the present application, the battery cells 20 of the battery pack may be removed from the battery mounting frame 10 after being depleted, and the fully-charged battery cells 20 may be mounted in the battery mounting frame 10.

The respective battery cell 20 is mounted on the battery mounting frame 10 and connected to a power input interface of the electric vehicle through the adapter assembly 30, wherein the respective battery cell 20 is connected by the adapter assembly 30 and forms a specific power transmission mode, and the battery pack provides the electric vehicle with electric energy in a specific power transmission mode. The respective battery cell 20 is conductively connected to the power input interface of the electric vehicle in a series and/or parallel manner through the adapter assembly 30.

In the preferred embodiment of the present application, the number of the battery cells 20 is N, where N>3. As an example, in this preferred implementation of the present application, the number of the battery cells 20 is 5, where a single battery cell 20 can provide the electric vehicle with the electric energy for a driving range of 100 kilometers. That is to say, at present, the battery pack can provide the electric vehicle with the electric energy required for a driving range of 500 kilometers. It is worth mentioning that in the preferred embodiment of the present application, the number of the mounting receptacles 11 of the battery mounting frame 10 is greater than or equal to the number of battery cells 20. That is to say, the number of the battery cells 20 to be mounted may be selected according to actual use requirements, and the respective battery cells 20 may form, through the adapter assembly 30, a specific power supply mode, such as a single battery power supply mode, that is, the adapter assembly 30 electrically connects a single battery cell 20 to the power input interface of the electric vehicle, while the other battery cells 20 are in an unconnected state. When the electric energy of a single battery cell 20 is consumed up and is in a depleted state, the adapter assembly 30 is electrically connected to other battery cell(s) 20, so that each of the battery cells 20 can be successively in a discharge state, which can reduce the number of charging and discharging cycles of the respective battery cell 20 and facilitate the increase in the service life of the battery cell.

Optionally, in other embodiments of the present application, the battery cells 20 of the battery pack are in a joint working mode, for example, the adapter assembly 30 can connect two or more battery cells 20 in series or in parallel and then electrically connect them to the power input interface of the electric vehicle. In this way, two or more battery cells 20 can simultaneously provide the electric vehicle with electric energy for working, which can not only meet the voltage and current requirements, but also improve the stability of the power supply operation and avoid power supply failure caused by a single battery fault.

It is worth mentioning that the respective battery cell 20 includes a plurality of battery elements and a charging and discharging controller, wherein the plurality of battery elements are connected in series to form a battery cell pack, and then connected to the charging and discharging controller. The charging and discharging controller controls the charging and discharging state of the respective battery cell 20, that is, each of the battery elements of the respective battery cell 20 can be charged through the charging and discharging controller, and when the respective battery cell 20 is conducted by the adapter assembly 30, the charging and discharging controller of the respective battery cell 20 controls the discharging of the respective battery cell 20. It is worth mentioning that in the preferred embodiment of the present application, the battery elements of the respective battery cell 20 may be, but are not limited to, lithium iron phosphate batteries, ternary lithium batteries, nickel-hydrogen batteries, capacitor batteries, etc. The charging and discharging controller of the respective battery cell 20 is connected to the adapter assembly 30, and controls the charging and discharging state of the respective battery cell 20 on the basis of a control signal of the adapter assembly 30.

The battery cells 20 may be detachably mounted in the mounting receptacles 11 of the battery mounting frame 10, wherein the battery cells 20 are spaced apart from each other by the mounting receptacles 11 of the battery mounting frame 10. Preferably, in the present application, the mounting receptacles 11 of the battery mounting frame 10 are configured as slot structures adapted to the battery cells 20, wherein the battery cells 20 are inserted into the mounting receptacles 11.

It should be noted that, in the preferred embodiment of the present application, the respective battery cell 20 is connected to the adapter assembly 30, and, through the adapter assembly 30, supplies power to the power input interface of the electric vehicle in a specific power supply mode. When the respective battery cell 20 of the battery pack is in a depleted state, the adapter assembly 30 stops the respective battery cell 20 from supplying power to the electric vehicle, thereby reducing the number of charging and discharging cycles of the battery.

The adapter assembly 30 includes input interfaces 31, an output interface 32, and a power management unit 33 connecting the input interfaces 31 and the output interface 32, wherein the input interfaces 31 of the adapter assembly 30 are electrically connected to the respective battery cells 20, and the output interface 32 is connected to the power input interface of the electric vehicle, and the power management unit 33 is located between the input interfaces 31 and the output interface 32, and is used to control the working states of the respective battery cells 20.

It can be understood that in the preferred embodiment of the present application, the respective input interfaces 31 of the adapter assembly 30 are collected in the power management unit 33, and then connected to the power input interface of the electric vehicle through the output interface 32. The power management unit 33 of the adapter assembly 30 may configure the battery cells 20 into a specific power supply mode according to the usage requirements of the electric vehicle.

As an example, in some embodiments of the present application, the power management unit 33 connects two or more battery cells 20 in series through the input interfaces 31 to form a power supply battery assembly; or the power management unit 33 connects two or more battery cells 20 in parallel through the input interfaces 31 to form a power supply battery assembly; or the power management unit 33 connects two or more battery cells 20 in parallel and in series through the input interfaces 31 to form a power supply battery assembly, and then connects the battery assembly to the power input interface of the electric vehicle through the output interface 32.

It should be noted that, in the preferred embodiment of the present application, the input interface 31 of the adapter assembly 30 is adapted to the power interface of the respective battery cell 20, and the output interface 32 of the adapter assembly 30 is adapted to the power input interface of the current electric vehicle. Therefore, in the preferred embodiment of the present application, the type of the output interface 32 of the adapter assembly 30 can be configured according to the type of the power input interface of the electric vehicle, so that the adapter assembly 30 can be mutually adapted to the power input interface of the electric vehicle.

The power management unit 33 between the input interface 31 and the output interface 32 is configured to conduct the input interface 31 corresponding to a specific battery cell 20 according to the electric energy requirements of the electric vehicle (in terms of the parameters such as voltage and current, etc.), so that the corresponding battery cell 20 is connected to the power input interface of the electric vehicle, and the respective battery cell 20 provides the electric vehicle with electric energy. It can be understood that, according to the electric energy requirements of the electric vehicle, the power management unit 33 conducts specific battery cells 20, such as battery cells 20a and 20b, and the battery cells 20a and 20b are connected in series; and the battery cells 20a and 20b in series are electrically connected to the power input interface of the electric vehicle through the adapter assembly 30, whereas other battery cells 20c, 20d, 20e, etc. are not conducted, and therefore are not in a discharging state.

The adapter assembly 30 further includes a charging adapter port 34, wherein one end of the charging adapter port 34 is connected to a charging port of the electric vehicle, and the other end of the charging adapter port 34 is connected to the respective battery cell 20 through the power management unit 33. That is, in the preferred embodiment of the present application, the battery pack can be implemented as a rechargeable battery device, and the depleted battery cells of the battery pack are charged by the charging port of the vehicle itself through the charging adapter port 34 of the adapter assembly 30.

The battery cells 20 of the battery pack are configured into one or more power supply modules by the adapter assembly 30, and the power supply modules supply power to electrical device(s) of the electric vehicle. As an example, in the preferred embodiment of the present application, several battery cells 20 connected in parallel and/or in series by the adapter assembly 30 form an independent power supply battery group, and the adapter assembly 30 controls the power supply battery group to supply power to an electric motor of the electric vehicle. In addition, the battery cells connected in parallel or in series by the adapter assembly 30 form other power supply battery group(s), and the adapter assembly 30 controls the power supply to other electrical device(s) of the electric vehicle, such as the vehicle's lighting and cooling/air conditioning/refrigeration system. Since the battery cells 20 of different modules are configured into different power supply modules by the adapter assembly 30, their power consumption speeds are different. Therefore, during the battery swapping process, the depleted battery cells can be replaced according to the power consumption degree of the specific battery cells 20 without replacing other batteries.

Preferably, in the preferred embodiment of the present application, the battery cells 20 of the battery pack are configured into a plurality of mutually independent power supply modules by the adapter assembly 30, and the discharging timing and discharging sequence of the respective battery cells 20 may be controlled by the adapter assembly 30. When a battery cell 20 in the battery pack is discharged, the power management unit 33 of the adapter assembly 30 turns off the corresponding battery cell 20 through the corresponding input interface 31, and turns on other battery cell(s) 20 to maintain the normal working state of the electric vehicle.

It can be understood that in the preferred embodiment of the present application, the battery cells 20 of the battery pack are independent of each other, and are discharged one by one in a cascade manner in a set working mode during the discharging process. This can fully utilize the electrical energy stored in each battery cell 20 and reduce the number of overall charging and discharging cycles of the respective battery cell 20.

In addition, it can be understood that in the preferred embodiment of the present application, when the respective battery cell 20 of the battery pack is depleted, the depleted battery cell can be removed accordingly and replaced with a fully-charged battery cell at the corresponding position. This allows the user to swap the battery according to actual needs without disassembling the entire battery pack, greatly simplifying the operation and shortening the time required for battery swapping.

The battery pack further includes a structural installation package 40, wherein the structural installation package 40 may be fixedly mounted in the battery tray of the electric vehicle, that is, the structural installation package 40 is suitable for the battery tray of the electric vehicle. The battery mounting frame 10, the battery cells 20 and the adapter assembly 30 of the battery pack are arranged in the structural installation package 40, and the battery cells 20 and the adapter assembly 30 inside are protected by the structural installation package 40.

It is worth mentioning that in the preferred embodiment of the present application, the battery mounting frame 10 is fixed inside the structural installation package 40, wherein the battery mounting frame 10 is detachably fixed to the structural installation package 40 by means of a snap-on or bolt-type connection. Therefore, it can be understood by those skilled in the art that when the battery of the electric vehicle is swapped, the battery may be swapped by disassembling the battery mounting frame 10 as a whole, that is, the battery may be swapped as a whole, or the respective battery cell 20 fixed to the battery mounting frame 10 can be replaced without disassembling the battery mounting frame 10 as a whole, which can not only simplify the process of swapping the battery, but can also be completed manually during the process of swapping the battery, without the need for mechanical device to disassemble and install.

It is worth mentioning that in the preferred embodiment of the present application, the structural installation package 40 is configured as a battery fixing mechanism adapted for the electric vehicle, wherein the battery mounting frame 10, the respective battery cell(s) 20 and the adapter assembly 30 are covered by the structural installation package 40, and the internal structure is protected by the structural installation package 40. In addition, the structural installation package 40 is a structure adapted for the electric vehicle, and the battery pack is fixed at a specific position of the electric vehicle through the structural installation package 40, that is, the battery pack is fixedly mounted in the electric vehicle through the structural installation package 40.

As an example, in the present application, the battery pack is a detachable battery assembly that may be mounted below the chassis of the electric vehicle, and the structural installation package 40 of the battery pack is configured to be suitable for the structure of the battery tray of the electric vehicle, wherein the structural installation package 40 of the battery pack is fixed in the battery tray of the chassis of the electric vehicle, and the battery mounting frame 10 and the respective battery cell(s) 20 are fixed by the structural installation package 40.

Optionally, in other optional embodiments of the present application, the structural installation package 40 is implemented as other types of mechanisms. As an example, when the battery pack is implemented as a side-pull plug-in battery assembly, the structural installation package of the battery pack is implemented as a pull-out installation structure. Optionally, when the battery pack is implemented as a parallel lateral plug-in battery assembly, the structural installation package of the battery pack is implemented as a battery fixing mechanism fixed above the chassis.

In short, the structural installation package 40 has a specific structure on the basis of the position where the battery pack is mounted, that is, the structural installation package 40 can fix the battery pack at a specific position of the electric vehicle. The structural installation package 40 includes a structural shell and a cover arranged on the structural shell, wherein the structural shell and the cover form an accommodating cavity for accommodating the battery mounting frame 10 and the respective battery cell(s) 20, and the battery mounting frame 10 is detachably mounted in the structural shell of the structural installation package.

The cover is arranged above, below or on a side of the structural shell, and the structural installation package 40 has a mechanism adapted to the electric vehicle. Therefore, in the preferred embodiment of the present application, the geometrical shape and structure of the structural installation package of the battery pack are not limited here. Preferably, the structural installation package forms a sealed structure, wherein the battery mounting frame 10 and the respective battery cell(s) 20 are sealed inside the structural installation package 40.

The fixing mechanism 12 of the battery mounting frame 10 is arranged in the mounting receptacle 11, and the respective battery cell 20 is fixed to the mounting receptacle 11 by the fixing mechanism 12. Preferably, in the preferred embodiment of the present application, the fixing mechanism 12 of the battery mounting frame 10 is implemented as an electromagnetic lock, wherein one end of the fixing mechanism 12 is arranged in the mounting receptacle 11, and the fixing mechanism 12 is in a locked state when being electrically conducted, that is, the respective battery cell 20 is fixed in the mounting receptacle 11 by the fixing mechanism 12. When the electromagnetic lock is not electrically conducted, the fixing mechanism 12 is in an open state, that is, the fixing mechanism 12 releases the respective battery cell 20, so that the depleted battery cell can be removed from the mounting receptacle 11.

The fixing mechanism 12 of the battery mounting frame 10 is electrically connected to the corresponding battery cell 20, wherein the fixing mechanism 12 detects the power level (namely “state of charge (SOC)”) of the respective battery cell 20 and fixes or releases the respective battery cell 20 according to the power level of the respective battery cell 20.

It can be understood that when the respective battery cell 20 is in a depleted state, the fixing mechanism 12 connected to the respective battery cell 20 is opened. At this time, the depleted battery cell can be removed from the battery mounting frame 10. When the fully-charged battery cell 20 is placed in the mounting receptacle 11 and connected to the fixing mechanism 12, the fixing mechanism 12 locks and fixes the respective battery cell 20 in the mounting receptacle 11.

When the battery of the electric vehicle is being swapped, the user can determine the current power level of each battery cell 20 according to the state of the fixing mechanism 12, and can remove the depleted battery cell 20 from the mounting receptacle 11. Since the fixing mechanism 12 corresponding to the fully-charged battery cell is in a closed state, the user can be prevented from taking the wrong battery cell during the battery swapping process.

It should be noted that the battery pack applicable to the electric vehicle of the present application is different from the battery pack of the prior art in that: the battery cells 20 of the battery pack can be disassembled and replaced as a whole along with the battery mounting frame 10, that is, when the battery cells 20 of the battery pack are all depleted, the user may remove the battery mounting frame 10 and the battery cells 20 from the structural installation package 40 and replace them with a new battery mounting frame 10 and fully-charged battery cells 20; the user may also swap the battery according to the actual remaining power (namely “state of charge (SOC)”) of the current battery cell(s) 20, that is, during the battery swapping process, the user may open the structural installation package 40, remove a depleted battery cell 20 from the respective mounting receptacle 11 of the battery mounting frame 10, and fill a fully-charged battery cell 20 into the mounting receptacle 11. It can be understood that by replacing the battery cell(s) 20 of the battery pack, the user can swap the battery as needed without disassembling all the battery cells or using a complex mechanical structure for disassembly and installation.

In addition, when the battery pack is swapped, the number of battery cells 20 mounted in the battery mounting frame 10 can be selectively determined. That is, the user can purchase the required number of batteries or power as needed. As an example, in the preferred embodiment of the present application, the number of mounting receptacles 11 of the battery mounting frame 10 is ten. The user can choose the number of battery cells 20 mounted in the battery mounting frame 10, such as five, six, eight or ten, according to the actual power consumption of the vehicle. It can be understood that as the number of batteries increases, the overall weight of the battery pack increases, and the power increases, which can allow the vehicle to have a longer driving range; and when the number of battery cells 20 is small, the weight of the electric vehicle can be reduced to a certain extent, and the normal driving of the vehicle is not affected. Simply speaking, during battery swapping, the user can choose the number of battery cells 20 to be mounted according to travel needs.

It is worth mentioning that in the preferred embodiment of the present application, the battery pack further includes a heat dissipation mechanism, a protective mechanism, a battery cell detection mechanism (not shown in the figures), etc., wherein the heat dissipation mechanism, the protective mechanism and the battery cell detection mechanism are arranged in the structural installation package 40 of the battery pack, and the heat dissipation mechanism, the protective mechanism and the battery cell detection mechanism are protected and fixed by the structural installation package. The heat dissipation mechanism is used to dissipate heat from the battery cells 20 in the battery pack to prevent the battery pack from overheating. The protective mechanism is located in the structural installation package, and is used to protect the battery pack, improve the structural strength of the battery pack and prevent the battery pack from burning, etc. The battery cell detection mechanism is arranged in the structural installation package 40, wherein the battery cell detection mechanism is connected to the battery cells 20, and is used to detect the power and working status of each of the battery cells 20. The specific structure and installation method of the heat dissipation mechanism, the protective mechanism and the battery cell detection mechanism are not elaboratively described here.

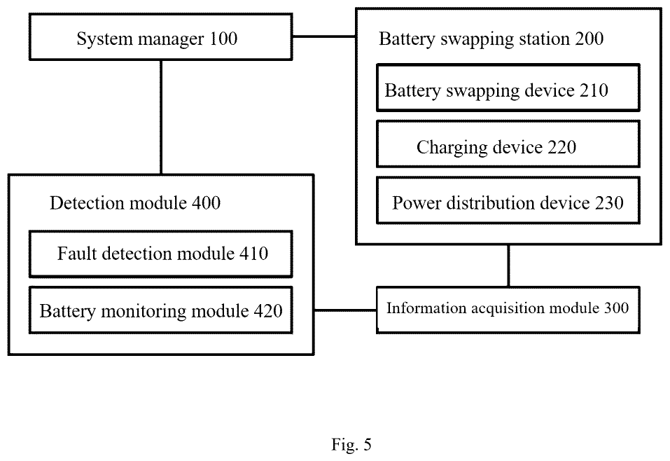

As shown in FIGS. 5 to 7, according to another aspect of the present application, the present disclosure further provides a battery swapping system, wherein the battery swapping system is used to manage batteries for electric vehicles and to supplement electric energy for electric vehicles by means of battery swapping.

The battery swapping system includes a system manager 100 and a battery swapping station 200, wherein the system manager 100 manages the battery pack used by the electric vehicle. When the electric vehicle needs to swap the battery, the battery swapping station 200 replaces the respective battery cell 20 in the battery pack for the electric vehicle to meet the electric energy demand of the electric vehicle. The system manager 100 and the battery swapping station 200 are connected in communication. The system manager 100 sends a battery swapping control instruction to the battery swapping station 200 according to the current electric energy demand of the electric vehicle, and then the battery swapping station 200 replaces the respective battery cell(s) 20 in the battery pack for the electric vehicle according to the battery swapping control instruction (or battery swapping plan instruction) of the system manager 100. The battery swapping station 200 removes the depleted battery cell(s) in the battery pack according to the user's demand for the purchased power, and installs a specified number of fully-charged battery cells, wherein the information of the battery cells 20 during the battery swapping process is acquired and transmitted to the system manager 100, and the system manager 100 manages the battery cells 20 according to the usage record, facilitating the increase in the service life of the battery.

The battery pack and battery swapping information of the electric vehicle are acquired to the system manager 100, and the system manager 100 formulates a corresponding battery swapping plan for the electric vehicle according to electricity consumption records of the electric vehicle. The electric vehicle sends a battery swapping instruction to the system manager 100, and the user formulates the battery swapping instruction according to the current power consumption demand required by the electric vehicle, such as a target driving range requirement, and the current remaining power reserve of the electric vehicle. The system manager 100 generates a battery swapping plan according to the battery swapping instruction of the electric vehicle, and sends the battery swapping plan to the electric vehicle and a corresponding battery swapping station 200. According to the battery swapping plan, the battery swapping station 200 removes depleted battery cells of the electric vehicle and installs fully-charged battery cells in the battery pack of the electric vehicle.

In order to facilitate management and increase the service life of the battery, the battery pack and battery cells of the electric vehicle each have a unique identity ID. The battery pack is mounted in the electric vehicle, so the identity ID of the battery pack is used to identify the electric vehicle, and the identity of the current vehicle can be uniquely determined by identifying the identity ID of the battery pack of the electric vehicle. It can be understood that in the preferred embodiment of the present application, the electric vehicle may be mounted with one or more battery packs. Therefore, the electric vehicle can have one or more identity IDs, and each identity ID can uniquely determine the identity of the electric vehicle.

The respective battery cell 20 has a unique identifier, wherein the identifier is used to identify the current battery cell 20. The identifier can be used to record the number of charging and discharging cycles of the respective battery cell 20, which is convenient for managing and maintaining the respective battery cell 20. The charging and discharging data of the respective battery cell 20 is transmitted and recorded in the system manager 100. When the system manager 100 receives a battery swapping request from the electric vehicle, it formulates a corresponding battery swapping plan according to the purchase instruction provided by the electric vehicle and the remaining power reserve of the electric vehicle. The system manager 100 sends the battery swapping plan to the battery swapping station 200, and the battery swapping station 200 replaces the depleted battery cell(s) 20 for the electric vehicle according to the battery swapping plan.

The battery swapping station 200 can configure different battery packs for electric vehicles according to the needs of users, and install the configured battery packs at specific positions of the vehicles. It should be noted that in the preferred embodiment of the present application, electric vehicle users do not need to purchase battery packs for electric vehicles and battery cells 20 required for battery swapping. They only need to pay the fees required to purchase electricity at the battery swapping station, which not only saves a lot of money required to purchase batteries, but also may save depreciation losses caused by battery loss.

It should be noted that in the preferred embodiment of the present application, the user can formulate a battery swapping request instruction in accordance with the power demand standard, the cost demand standard or the range demand standard, and send the battery swapping request instruction to the system manager 100. The system manager 100 formulates, according to the purchase instruction and the current remaining power of the electric vehicle, a battery swapping plan that matches the user's needs, and sends the battery swapping plan to the battery swapping station 200, and the battery swapping station 200 swaps the battery for the electric vehicle according to the battery swapping plan. As an example, in the preferred embodiment of the present application, the user can formulate the purchase instruction according to the current vehicle target driving range. For example, if the user sets the target driving range of the electric vehicle to 500 kilometers, the system manager 100 can formulate a suitable battery swapping plan according to the current vehicle target driving range and vehicle information, such as increasing or decreasing the number of battery cells 20 in the battery pack of the current vehicle, so that the electric vehicle has a sufficient driving range after battery swapping. Optionally, the user may also send the purchase instruction according to the cost required to purchase electricity. For example, during a battery swapping process, the purchase instruction sent by the user is to replace a specific number of the battery cells 20, and the system manager 100 generates a corresponding battery swapping plan according to the purchase instruction.

The battery swapping station 200 includes a battery swapping device 210, a charging device 220 and a power distribution device 230, wherein the battery swapping device 210 is configured to disassemble the depleted battery cells of the electric vehicle and install the configured and ready fully-charged battery cells into the battery pack of the electric vehicle, and the charging device 220 is configured to charge the depleted battery cells and store the battery cells 20; and instructions of the power distribution device 230 and the system manager 100 are issued for configuring battery cells 20 for the electric vehicle to meet the power consumption demand of the electric vehicle.

The battery swapping device 210 removes the depleted battery cells and transports them to the charging device 220, and the charging device 220 charges the depleted battery cells. The battery cells 20 are mounted in the battery pack of the electric vehicle, and the power distribution device 230 configures the battery cells to meet the actual use requirements of the electric vehicle. The power distribution device 230 configures the battery cells 20 in the battery pack according to the battery swapping plan. For example, the power distribution device 230 configures a discharging plan of the battery cells 20, and arranges a suitable discharging sequence for the respective battery cells 20 in the battery pack, so that the battery cells 20 used in the battery pack in a cascade manner (“cascade utilization”) are charged and discharged. The respective battery cells 20 are reasonably utilized, which facilitates the reduction of the number of battery charging and discharging cycles and the increase in the service life of the battery.

In the preferred embodiment of the present application, batteries required by electric vehicles are provided by an battery asset center to battery swapping stations or vehicle owners in the form of leasing or selling. As an example, the battery swapping station 200 obtains battery cells 20 from the battery asset center in the form of leasing according to a demand. During the battery swapping process of the electric vehicle, the battery swapping station 200 removes the depleted battery cells from the electric vehicle and provides the fully-charged battery cells to the electric vehicle. The battery asset center manages, allocates, leases, recycles and maintains the battery cells 20 used by the electric vehicle, so that the battery swapping station only needs to obtain batteries from the battery asset center according to the power consumption demand of the electric vehicle, and then returns the batteries that need to be recycled or maintained to the battery asset center, and the batteries are centrally managed and maintained by the battery asset center. This can save electric vehicle owners a lot of money on battery expenses to a great extent, and there is no need to maintain the batteries.

The battery swapping system further includes an information acquisition module 300, wherein the information acquisition module 300 and the system manager 100 are connected in communication, and the information acquisition unit 300 acquires data of the electric vehicle for battery swapping and information about charging and discharging of each battery cell 20, and wherein the information acquisition unit 300 transmits the acquired data information to the system manager 100, and the system manager 100 uniformly manages the battery cells 20 according to the acquired data information.

The information acquisition module 300 may be, but is not limited to, a scanning and identification device. As an example, in the preferred embodiment of the present application, the information acquisition module 300 is implemented as a scanning and identification apparatus, and the information acquisition module 300 acquires and identifies the identifier of the respective battery cell 20 and the identity ID of the battery pack. During the battery swapping process of the electric vehicle by the battery swapping station 200, the identity ID of the battery pack is acquired by the information acquisition module 300 to identify the vehicle information about the current vehicle, and then the battery swapping station 200 replaces the battery of the electric vehicle according to the identified identity ID information and the corresponding battery swapping plan. The information acquisition module 300 can identify the identifiers of the battery cells 20, and determine, in accordance with the identified identifiers, depleted battery cells that need to be replaced and fully-charged battery cells that need to be mounted.

It can be understood that the information acquisition module 300 may use the information about charging and discharging of each battery cell 20 and the configuration information of the fully-charged battery cells in the respective battery pack to determine whether the current battery swapping process of the electric vehicle complies with the battery swapping plan of the electric vehicle.

Optionally, in the preferred embodiment of the present application, the information acquisition module 300 may be connected in communication with the electric vehicle, the electric vehicle may send identity information to the information acquisition module 300, and the information acquisition module 300 sends data information of the battery cells 20 configured during the battery swapping process to the electric vehicle.

The battery swapping system further includes a detection module 400, and the detection module 400 detects the battery cells 20 to determine whether the battery cells 20 need to be replaced, that is, the detection module 400 detects the power reserve and charging and discharging safety of the battery cells 20, etc. The detection module 400 includes a fault detection module 410 and a battery monitoring module 420, wherein the fault detection module 410 is configured to perform fault detection on the battery cells 20, and the battery monitoring module 420 is configured to monitor the usage state of the battery during use.

As an example, in the preferred embodiment of the present application, the detection module 400 is connected in communication with the system manager 100, wherein the detecting data information of the detection module 400 is transmitted to the system manager 100, and when the detection module 400 detects a battery fault or failure, the system manager 100 records it and formulates a corresponding battery swapping plan.

In particular, in the preferred embodiment of the present application, the fault detection module 410 is arranged in the charging device 220 of the battery swapping station 200, and the fault detection module 410 performs fault detection on the battery cells 20 during the battery charging process, and determines whether the battery cells 20 are currently faulty. The battery monitoring module 420 of the detection module 400 is arranged in the battery pack, wherein the battery monitoring module 420 performs real-time monitoring on the battery cells 20 mounted in the battery pack, and when the battery monitoring module 420 detects that the battery cells 20 have a safety hazard, the battery detection module 420 transmits various monitoring data information to the system manager 100, and then the system manager 100 makes a battery swapping plan to avoid a vehicle fault.

It can be understood that during the discharge process of the battery cells in the battery pack, the battery monitoring module 420 detects each of the battery cells 20, wherein the monitoring data of the battery monitoring module 420 is transmitted to the electric vehicle so that the driver of the electric vehicle formulate a battery swapping request in a timely manner according to the detection data.

According to another aspect of the present application, the present application further provides a battery swapping method for an electric vehicle, wherein the battery swapping method includes the following steps:
(a) obtaining a purchase instruction for battery swapping for the electric vehicle, and formulating a battery swapping plan on the basis of the purchase instruction and the remaining power of the electric vehicle; and
(b) on the basis of the battery swapping plan, removing depleted battery cells from the electric vehicle and installing fully-charged battery cells.

In step (a) of the battery swapping method of the above preferred embodiment of the present disclosure, the electric vehicle sends the purchase instruction and the remaining power information of the electric vehicle to the system manager 100, or an information acquisition module obtains the purchase instruction of the electric vehicle, and transmits the purchase instruction to the system manager 100.

In step (a) of the battery swapping method of the above preferred embodiment of the present disclosure, the purchase instruction is formulated on the basis of a power purchase demand, and the purchase instruction is sent to the system manager 100. It is worth mentioning that in the preferred embodiment of the present application, the user generates the purchase instruction according to the cost of purchasing power or based on the number of battery cells.

In the battery swapping method of the above preferred embodiment of the present disclosure, the battery pack of the electric vehicle has a unique identity ID, and each battery cell 20 has a unique identifier. The electric vehicle is identified by identifying the identity ID, and the charging and discharging cycles and usage records of the battery cells 20 are recorded by the respective identifiers.

The battery swapping method of the above preferred embodiment of the present disclosure further includes the following step: (c) acquiring battery information of the depleted battery cells and the fully-charged battery cells, and uploading the battery information to the system manager 200, and the system manager 200 records the number of charging and discharging cycles and usage records of the battery cells 20.

The battery swapping method of the above preferred embodiment of the present disclosure further includes the following step: (d) configuring the discharge sequence of the respective battery cells 20 in the electric vehicle on the basis of the battery swapping plan of the electric vehicle.

It should be understood by those skilled in the art that the embodiments of the present disclosure described above and shown in the accompanying drawings are only examples and do not limit the present disclosure. The objectives of the present disclosure have been fully and effectively achieved. The functional and structural principles of the present disclosure have been shown and described in the embodiments, and the implementations of the present disclosure may be changed or modified in any way without departing from the principles.

The technical scope of the present disclosure is not limited to the contents in the above description. Those skilled in the art can make various variations and modifications to the above embodiments without departing from the technical idea of the present disclosure, and these variations and modifications all belong to the scope of protection of the present application.

What is claimed is:

1. A battery swapping system for providing electric energy to an electric vehicle by means of battery swapping, wherein the electric vehicle comprises a plurality of battery cells, the battery swapping system comprising:
a system manager formulating a battery swapping plan on the basis of a purchase instruction and the remaining power of the electric vehicle; and
a battery swapping station, wherein the system manager sends the battery swapping plan to the battery swapping station, and on the basis of the battery swapping plan, the battery swapping station removes depleted battery cells of the electric vehicle and installs a corresponding number of fully-charged battery cells instead.

2. The battery swapping system according to claim 1, wherein the battery swapping station comprises a battery swapping device, a charging device and a power distribution device, wherein the battery swapping device is configured to disassemble the depleted battery cells of the electric vehicle and install the configured and ready fully-charged battery cells into a battery pack of the electric vehicle, and the charging device is configured to charge the depleted battery cells and store the battery cells; and instructions of the power distribution device and the system manager are issued for configuring the battery cells for the electric vehicle to meet a power consumption demand of the electric vehicle.

3. The battery swapping system according to claim 1, further comprising an information acquisition module, wherein the information acquisition module acquires data of the electric vehicle being swapped and information about charging and discharging of each battery cell, wherein the information acquisition module transmits the acquired data and information to the system manager.

4. The battery swapping system according to claim 1, further comprising a detection module for detecting the battery cells and transmitting detection results to the system manager.

5. The battery swapping system according to claim 4, wherein the detection module comprises a fault detection module and a battery monitoring module, wherein the fault detection module is configured to perform fault detection on the battery cells, and the battery monitoring module is configured to monitor a usage state of a battery during use.

6. A battery swapping method for an electric vehicle, wherein the battery swapping method comprises the following steps:
(a) obtaining a purchase instruction for battery swapping of the electric vehicle, and formulating a battery swapping plan on the basis of the purchase instruction and the remaining power of the electric vehicle; and
(b) on the basis of the battery swapping plan, removing depleted battery cells from the electric vehicle and installing fully-charged battery cells.

7. The battery swapping method according to claim 6, wherein in step (a) of the battery swapping method, the electric vehicle sends the purchase instruction and the remaining power information of the electric vehicle to a system manager, or an information acquisition module obtains the purchase instruction of the electric vehicle, and transmits the purchase instruction to the system manager.

8. The battery swapping method according to claim 6, wherein in step (a) of the battery swapping method, the purchase instruction is formulated on the basis of a power purchase demand, and the purchase instruction is sent to a system manager.

9. The battery swapping method according to claim 6, wherein the battery swapping method further comprises the following step: (c) acquiring battery information of the depleted battery cells and the fully-charged battery cells, and uploading the battery information to a system manager, and the system manager records the number of charging and discharging cycles and usage records of the battery cells.

10. The battery swapping method according to claim 6, wherein the battery swapping method further comprises the following step: (d) configuring a discharge sequence of the respective battery cells in the electric vehicle on the basis of the battery swapping plan of the electric vehicle.

11. A battery pack for an electric vehicle suitable for use in the battery swapping system according to claim 1, comprising:
a battery mounting frame;
a plurality of battery cells, wherein the plurality of battery cells are detachably mounted on the battery mounting frame; and
an adapter assembly, wherein the adapter assembly comprises an input interface, an output interface and a power management unit connecting the input interface and the output interface, the respective battery cells are connected to the input interface of the adapter assembly, and the output interface is adapted to connect to a power input terminal of the electric vehicle, and wherein the power management unit converts electric energy output by the battery cells into electric energy adapted to input to the electric vehicle;
wherein the respective battery cells are independent of each other, and each can be removed from and mounted to the battery mounting frame separately.

12. The battery pack according to claim 11, wherein the battery mounting frame comprises a plurality of mounting receptacles and a fixing mechanism, and the battery cells can be fixed in the mounting receptacles by the fixing mechanism.

13. The battery pack according to claim 12, wherein the fixing mechanism is configured as an electromagnetic lock, and one end thereof is arranged in the mounting receptacle, and wherein the electromagnetic lock, when being electrically conducted, is in a locked state to fix the respective battery cell in the mounting receptacle, and the electromagnetic lock, when being not electrically conducted, is in an open state to release the respective battery cell.

14. The battery pack according to claim 12, wherein the fixing mechanism is electrically connected to the corresponding battery cell, and wherein the fixing mechanism detects the power level of the respective battery cell and fixes or releases the respective battery cell according to the power level of the respective battery cell.

15. The battery pack according to claim 11, wherein the adapter assembly can electrically connect a single battery cell to the power input terminal of the electric vehicle, with the other battery cells in an unconnected state, to form a single battery power supply mode.

16. The battery pack according to claim 11, wherein the adapter assembly can connect two or more battery cells in series or in parallel and then electrically connect them to the power input terminal of the electric vehicle, so that the battery cells are in a joint working mode.

17. The battery pack according to claim 11, wherein the battery cells of the battery pack are configured into a plurality of mutually independent power supply modules by the adapter assembly, and the discharging timing and discharging sequence of the respective battery cells can be controlled by the adapter assembly.

18. The battery pack according to claim 11, wherein the adapter assembly further comprises a charging adapter port, wherein one end of the charging adapter port is configured to be connected to a charging port of the electric vehicle, and the other end thereof to the respective battery cell through the power management unit, so that the depleted battery cells of the battery pack are rechargeable through the charging adapter port.

19. The battery pack according to claim 11, further comprising a structural installation package, wherein the battery mounting frame, the battery cells and the adapter assembly are arranged in the structural installation package, and the structural installation package is configured to be fixedly mounted in a battery tray of the electric vehicle.

20. The battery pack according to claim 19, wherein the structural installation package comprises a structural shell and a cover arranged on the structural shell, wherein the structural shell and the cover form an accommodating cavity for accommodating the battery mounting frame and the respective battery cells, and wherein the battery mounting frame is detachably mounted in the structural shell.
